(19) United States
(12) Patent Application Publication
(10) Pub. No.: US 2011/0281000 A1
(43) Pub. Date: Nov. 17, 2011

(54) HIGH PRESSURE COFFEE BREWER

(75) Inventors: Tarcisio Vergani, (US); Ayron Capon, (US)

(73) Assignee: CRANE MERCHANDISING SYSTEMS, INC., Bridgeton, MO (US)

(21) Appl. No.: 13/106,723

(22) Filed: May 12, 2011

Related U.S. Application Data
(60) Provisional application No. 61/333,941, filed on May 12, 2010.

(51) Int. Cl. A23F 5/24; A23F 5/08

(52) U.S. Cl. 426/231; 99/323.3; 426/433

(57) ABSTRACT

A brewer for brewing different beverages requiring different brewing pressures does not employ an internal valve adjusting an outlet opening to achieve the different pressures. Instead, compression of grinds within the brewer and pressure of water injected to brew the beverage is employed to control the brewing pressure, achieving a greater consistency of brew quality over time. Overheating is implemented for certain beverages based on a time since a last vend, and a back check valve between a flow meter and pump provides greater control over the pump output.

### CROSS-REFERENCE TO RELATED APPLICATIONS

This application claims priority to U.S. Provisional Patent Application Ser. No. 61/333,941 entitled “HIGH PRESSURE COFFEE BREWER” and filed on May 12, 2010. The content of the above-identified patent document is incorporated herein by reference.

### TECHNICAL FIELD

The present application relates generally to beverage brewing mechanisms and, more specifically, to brewers for brewing beverages requiring different brewing pressures and temperatures.

### BACKGROUND

Systems for brewing beverages such as espresso must often be made specific to a particular brew (e.g., North American coffee, north European and/or Italian espresso, etc.) or adjustable to prepare multiple types of beverages. One category of brewer design, for example, uses an internal valve and/or a variable volume brew chamber for producing both low and high pressure brewed beverages. Such systems are described in EP 1 267 685 B1 and EP 1 267 686 B1, the content of which is incorporated herein by reference. Within those designs, movement of a spring-biased internal shuttle opens or closes a valve to alter the size of an opening for an outlet from the brewing chamber, thereby changing the pressure within the brewing chamber. Such movement represents a point of mechanical wear that can, over time, result in inconsistency in the quality of the beverage brewed.

There is, therefore, a need in the art for an improved beverage brewing system.

### SUMMARY

A brewer for brewing different beverages requiring different brewing pressures does not employ an internal valve adjusting an outlet opening to achieve the different pressures. Instead, compression of grinds within the brewer and pressure of water injected to brew the beverage is employed to control the brewing pressure, achieving a greater consistency of brew quality over time. Overheating is implemented for certain beverages based on a time since a last vend, and a back check valve between a flow meter and pump provides greater control over the pump output.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a front perspective view of a coffee vendor for delivering brewed beverages requiring different brewing pressures according to one embodiment of the present disclosure;

FIG. 1B is a front view of the vendor of FIG. 1A with the service door open, revealing internal features of the vendor;

FIG. 2 is a block diagram of portions of the control system for the vendor of FIGS. 1A and 1B;

FIG. 3A is a vertical cross-section of portions of a brewer within the vendor of FIGS. 1A and 1B;

FIG. 3B is a sectional view of the brewer depicted in FIG. 3A taken at section lines 3B-3B;

FIGS. 4A through 4D are sectional views similar to FIG. 3B that illustrate operation of the brewer of FIGS. 3A and 3B;

FIG. 5 is a view from the rear into the cabinet of the vendor of FIGS. 1A and 1B, with cabinet sidewalls removed to show additional components employed in brewing beverages; and

FIG. 6 is a high level flow diagram illustrating a process for brewing a beverage within the vendor of FIGS. 1A and 1B.

### DETAILED DESCRIPTION

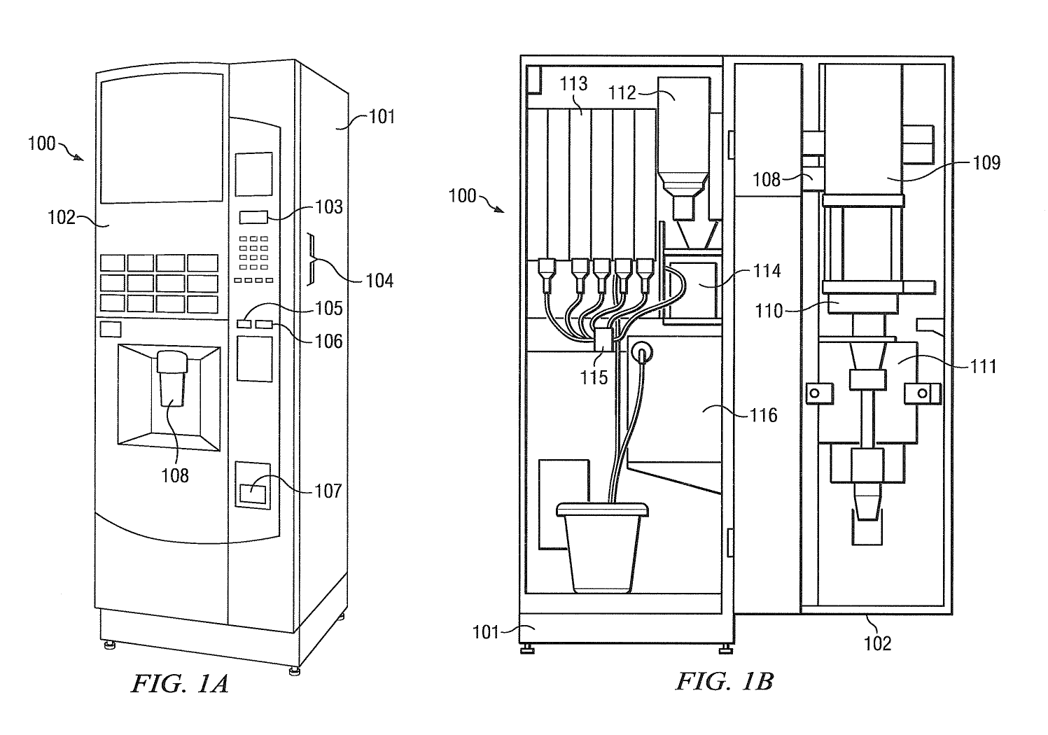

FIGS. 1A through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine currency handling system.

FIG. 1A is a front perspective view of a coffee vendor for delivering brewed beverages requiring different brewing pressures according to one embodiment of the present disclosure. The vendor 100 includes a cabinet 101 with a door 102 on the front of the cabinet. Mounted on the door 102 is a display 103 such as a continuous or segmented liquid crystal display (LCD), for displaying messages to the customer. Also mounted on the door 102 is a selection keypad 104 with buttons optionally associated with selection decals or other identifiers for enabling the customer to make a vend selection. One or more of slot(s) 105 and button(s) 106 communicates with a payment system inside the cabinet 101, such as a coin acceptor, a bill validator and/or recycler, or both. In the exemplary embodiment, a single slot providing access to a coin acceptor is provided, together with a coin return button that, when actuated, causes deposited coins to be returned to the coin return 107. Also mounted in the front of door 102 is a delivery station 108, to which a cup and the brewed beverage are delivered for removal by the customer.

FIG. 1B is a front view of the vendor 100 of FIG. 1A with the door 102 open, revealing internal features of the vendor 100. Mounted on the inside of door 102 is a service keypad 108, which is connected to a vending machine controller (not visible in FIG. 1B) also mounted on the inside of door 102. Cup turret 109 mounted on the inside of door 102 holds empty cups for delivery by cup drop unit 110 to cup catcher 111 at the delivery station 108. Inside cabinet 101, a fresh beans canister 112 holds coffee beans to be ground for preparation of coffee-based beverages, and ingredients canisters 113 hold other ingredients (e.g., flavorings) for use in brewing beverages. Canisters 112 and 113 are communicably coupled to dispense head 115, to deliver predetermined quantities of ingredients thereto. Wasted from brewer 114 is received by container 116. Brewed beverages from brewer 114, mixed with other ingredients from canisters 113, are delivered by dispense head 115 to a cup held within cup catcher 111 at the delivery station 108. The customer may retrieve the cup and contents from the delivery station.

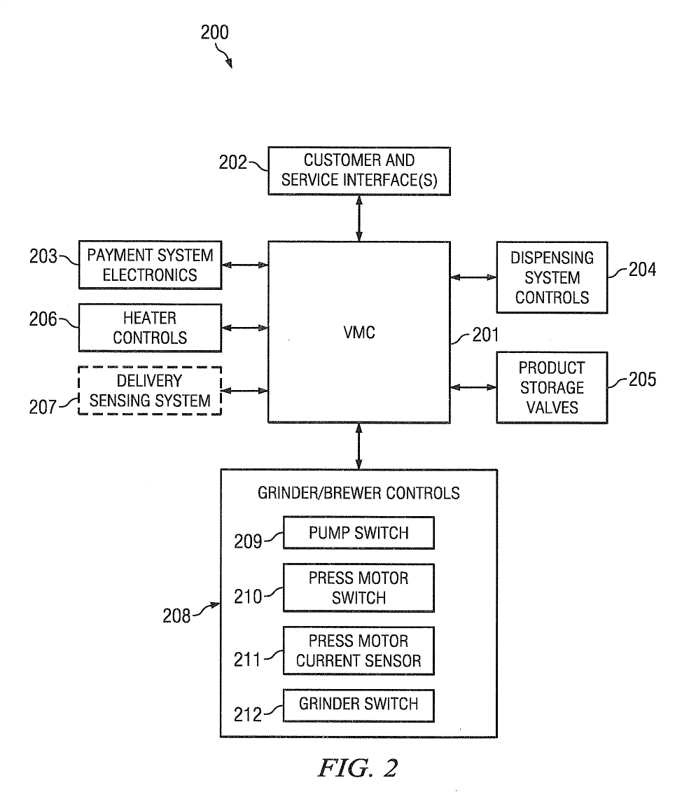

FIG. 2 is a block diagram of portions of the control system 200 of the vendor 100 of FIGS. 1A and 1B. Control system 200 includes a vending machine controller (VMC) 201 coupled by wiring or other means for communicating signals to and/or receiving such signals from: a customer interface 202, which includes at least customer display 103 and keypad 104 and service keypad 108 in the exemplary embodiment; payment system electronics 203, including at least the coin acceptor mounted behind slot 105 and coin return button 106 in the exemplary embodiment; dispensing system controls 204 controlling rotation of cup turret 109 and release of cups from cup turret 109 through cup drop unit 110 to cup catcher 111; product storage valves 205 controlling dispensation of beans from bean canister 112 to the grinder (located at the top of the brewer) and ingredients from the ingredients canisters 113 to the dispensing head 115; heater controls 206; an optional delivery sensing system 207; and grinder and brewer controls 208, controlling operation of the brewer 114 and the associated grinder (not separately visible in FIG. 1B). Controller 201 is programmed to operate the controls coupled thereto in a manner known in the art, and as described in further detail below.

Those skilled in the art will recognize that the complete structure of a vending machine is not depicted in the drawings, and the complete details of the structure and operation of the brewed beverage vendor is not described herein. Instead, for simplicity and clarity, only so much of the structure and operation of a brewed beverage vendor as is unique to the present disclosure or necessary for an understanding of the present disclosure is depicted and described. Additional details regarding the structure and operation of one brewed beverage vendor of the type in which the improvements of the present disclosure may be implemented may be found by reference to an “Evolution” model brewed beverage vendor, available from Crane Merchandising Systems and described in Evolution Technical Manual, part no. PR10909000 issue C 02/09 available at www.cranems.co.uk/techdocs/PR10909000revCsml.pdf and/or Evolution Operators Manual, part no. PR 10908000 issue B 04/06 available at www.cranems.co.uk/techdocs/PR10908000IssueB.pdf, both of which are incorporated herein by reference.

Brewer 114 is adapted in the present disclosure to brew beverages requiring different pressures, such as coffee (lower pressure) and espresso (higher pressure). Unlike the systems described above, however, the outlet aperture is not changed in order to achieve the requisite pressure. Instead, the grind of the coffee within the brewer, together with the pressure applied to the grind and the pressure of the water supplied to the brewer, is employed to achieve the required brewing pressure.

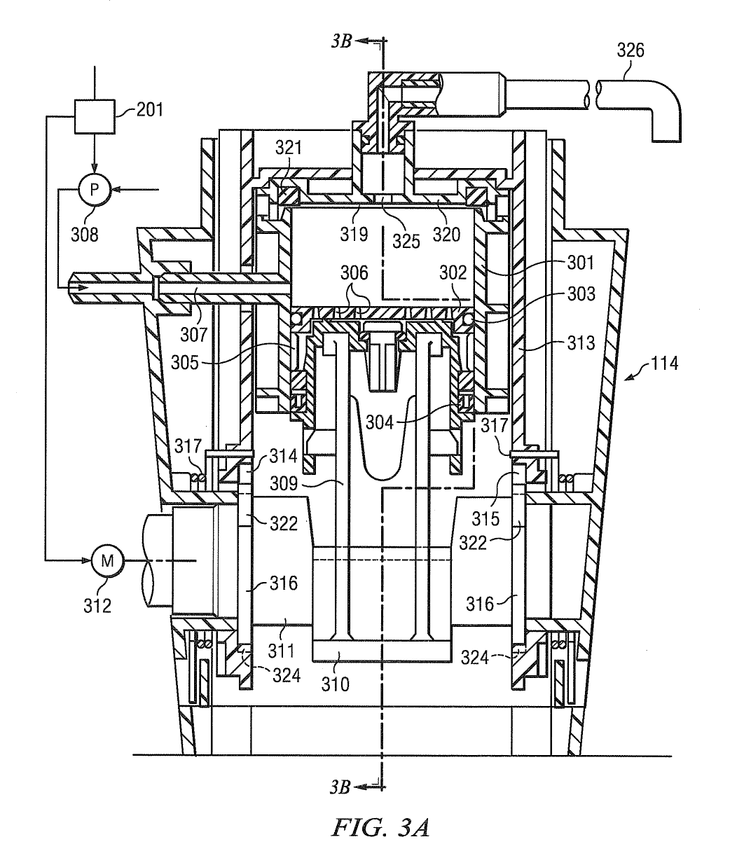

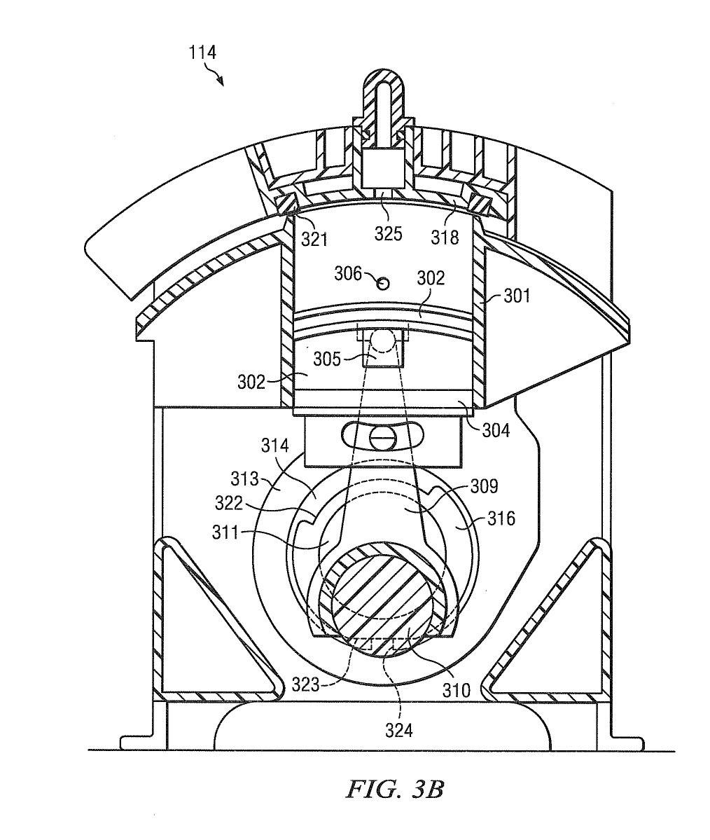

FIG. 3A is a vertical section of portions of a brewer 114 within the vendor 100 of FIGS. 1A and 1B. FIG. 3B is a cross-section of the brewer 114 depicted in FIG. 3A taken at section lines 3B-3B. Brewer 114 includes a housing formed in part by a cylinder 301. A press 302 that is movable within the cylinder 301 is provided with seals 303-304. Apertures 305 in fluid communication with dispensing apertures 306 are bounded by seals 303-304 and may be selectively brought into fluid communication with a supply line 307 for heated, pressurized water supplied by pump 308 by movement of press 302. Press 302 is connected by drive rod 309 to a crank pin 310, which in turn forms part of a crankshaft 311 connected to motor 312. Switches 209 and 210 controlling pump 308 and motor 312 are among the grinder and brewer controls 208. In addition, a pump motor current sensor 211 is employed to determine compression of the grinds as described in further detail below.

A rocker arm 313 includes control apertures 314 and 315 each having an edge engaging on curved disk 316, and is biased by two coil springs 317. Rocker arm 313 includes a cover 318 in which a filter plate 319 and filter 320 are fitted. Filter plate 319 is provided with a sealing ring 321, fitting against an end of the cylinder 301. Curved disk 316 is fitted on the crankshaft 311 and includes recesses 322 and 323. Cam 324 in control apertures 314 and 315 of rocker arm 313 is designed to engage curved disc 316 or recesses 322, 323. Outlet 325 for the brewed beverage from the brewing chamber formed by cylinder 301, press 302 and filter plate 319/filter 320 is connected by outlet piping and/or tubing 326 to the dispense head 115. As shown, outlet 325 does not include a valve or other movable mechanism for controlling an effective size of the outlet (and therefore pressure within the brewing chamber).

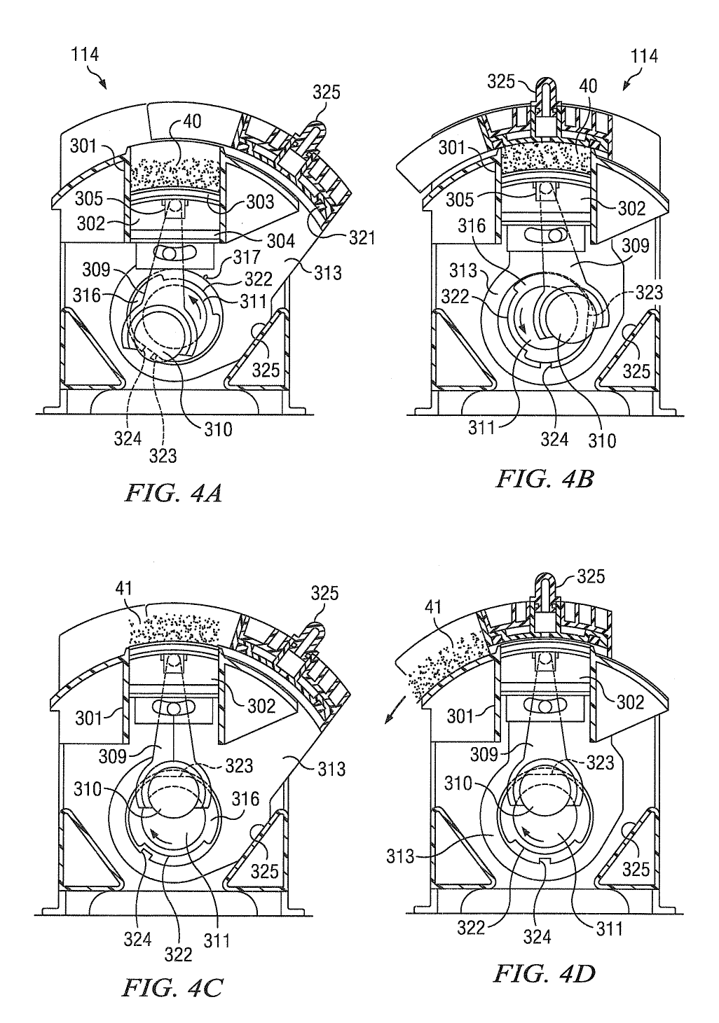

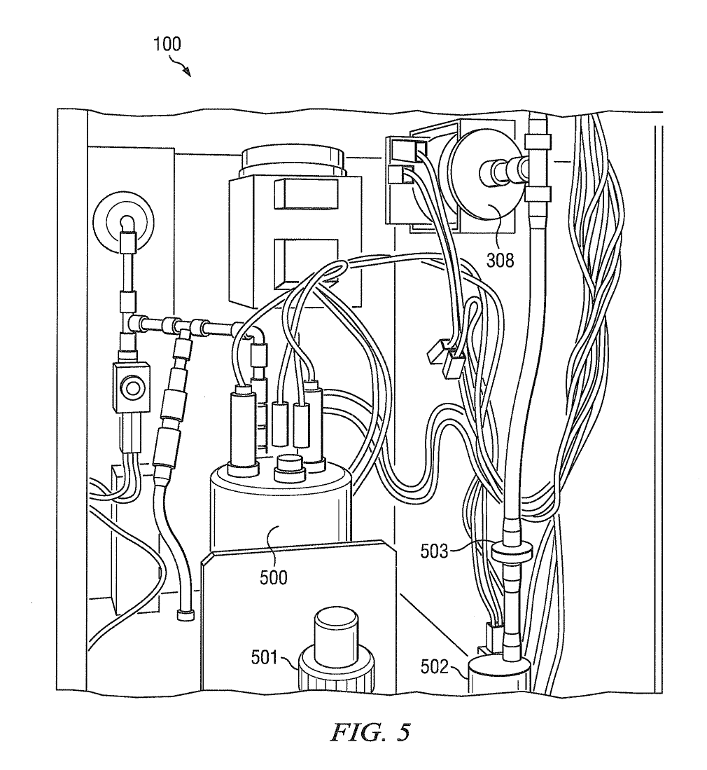

FIGS. 4A through 4D illustrate operation of the brewer of FIGS. 3A and 3B. The view depicted is similar to that of FIG. 3B. During a first phase of the beverage-brewing process (FIG. 4A) the rocker arm 313 is situated in such a position that the aperture of cylinder 301 is open, so that coffee grinds 40 may be fed by gravity from a grinder (not shown) located above the brewing chamber onto the press 302. The quantity and type of grind of coffee grinds is dependent, for example, on the desired product. For example, a small quantity of a first type of grind is required for “ordinary” or North American coffee, and a larger quantity of a second type of grind is required for espresso coffee.

In the position illustrated in FIG. 4A, rocker arm 313 rests against stop 325 of the housing for brewer 114. Cam 324 is situated in recess 323 and, through the action of coil springs 317, the rocker arm 313 is pressed away from cylinder 301. In addition, the coil springs 317 also to generate a clockwise (as seen in FIG. 4A) rotational force on rocker arm 313, biasing rocker arm 313 toward a position over the end of cylinder 301.

Motor 312 turns the crankshaft 311 clockwise, with press 302 moving downwards and at the same time rocker arm 313 moved to the left until positioned over the open end of cylinder 301. Further clockwise rotation of crankshaft 311 pulls rocker arm 313 downwards since, once the limit of motion to the left is reached, on reaching the end of the recess 323 the cam 324 is pressed downwards by the curved disk, against the spring force of springs 317. As a result, seal 321 of filter plate 319 engages the end of cylinder 301. Press 302, driven by motor 312 still turning clockwise, then moves upwards again, so that coffee grinds 40 are compressed by press 302 against the filter plate 319 as depicted in FIG. 4B. Depending on the quantity of coffee, the press will stop at a higher or lower level, but with region containing grinds 40 always in communication with the supply line 307. The proper compression of the grinds 40 for the brew desired is controlled by controller 201 based on the current draw of motor 312, as described in further detail below.

Heated water is then supplied through supply line 307 at a pressure controlled by controller 201 by controlling the output of the pump 308 to obtain the desired product. For traditional North American coffee, a relatively low pressure will be used, while for espresso coffee the pressure will be higher (for example, 9-11 bar). In both cases the heated water passes into the grinds 40 through apertures 306 and leaves the grinds 40 again by way of filter plate 319 and between filter plate 319 and cover 318 to be dispensed through outlet 325, during which process the grinds 40 are retained by the filter plate.

After the beverage has been brewed, motor 312 is driven counter-clockwise (as seen in FIG. 4C). During this return motion the “coffee-tablet” 41 of compressed grinds remains adhering to the cylinder 301, and not to the rocker arm 313 because of a scraper strip. The motion of rocker arm 313 progresses until cam 324 falls into recess 323 and, owing to the spring force, rocker arm 313 moves upwards to break the seal between seal edge 321 and the top end of cylinder 301. The rocker arm 313 then moves along with the crankshaft 311. As rocker arm 313 moves to the position shown in FIG. 4C, the press 302 moves up. The rocker arm 313 is then pressed downwards by the fact that crank 311 continues rotating and the “end” of recess 323 is reached. Upon further rotation of crank 311, press 302 moves back to top center, pushing tablet 41 above the level of cylinder 301. Cam 324 then goes into recess 322 and, under the influence of coil springs 317, rocker arm 313 moves upwards and to the left, pushing the tablet 41 off the surface of press 302 as shown in FIG. 4D. On further rotation, when there is engagement with the “end” of recess 322, cam 30 rotates until the rocker arm 313 returns to original position shown in FIG. 4A.

Unlike the internal valve systems described above, brewer 114 does not include a valve in the opening 325 above filter 320 leading to piping/tubing 326, adjusted to control brewing pressure by changing the size of the opening allowing brewed beverage to flow out of the brewer. Instead, brewer 114 relies on the grind of the coffee employed, the force applied by press 302 (as determined from the current draw of motor 312 driving press 302) and the pressure of water injected into the brewer 114 through supply line 307 by pump 308. The press motor current sensor 211 may be employed to determine the compression being applied to the grinds, as greater compression will require higher current draw. The pump 308 may be operated at variable speeds to generate different pressures of the heated water being pumped. Thus, brewing a North American coffee would involve producing a first quantity and first type of grinds, applying a first compression to those grinds during brewing and pumping water in at a first pressure during brewing, while brewing a north European espresso would involved producing a second quantity and second type of grinds, applying a second compression and pumping water at a second pressure.

FIG. 5 is a view from the rear into the cabinet of the vendor of FIGS. 1A and 1B, with cabinet sidewalls removed to show additional components employed in brewing beverages. A 350 milliliter (ml) brass heater 500 having an internal heating element is employed to heat water supplied to vendor 100. Depending on the length of time since the vendor 100 last dispensed a drink, the heating algorithm applied by controller 201 to heater controls 206 for heater 500 varies depending upon the time since the last beverage was vended. The heating element is generally controlled by controller 201 based on thermocouple temperature measurements, to maintain the water in heater at a predetermined temperature. However, when the user selects certain beverages, such as an espresso, the controller 201 activates an overheating algorithm as set forth in TABLE I below.

TABLE I

Time between vends
(MINS)

| From | To | Heater on time |
|---|---|---|
| 0.00 | 1.59 | 4.00 |
| 2.00 | 5.59 | 5.00 |
| 6.00 | 9.59 | 6.00 |
| 10.00 | 13.59 | 7.00 |
| 14.00 | 17.59 | 8.00 |
| 18.00 | 21.59 | 9.00 |
| 22.00 | 25.59 | 10.00 |
| 26.00 | 29.59 | 11.00 |
| 30.00 | * | 16.00 |

Overheating time is set to 0 is the vendor is in standby mode or is not preparing beverages requiring overheating. The heater on time is measured from when the brewer 114 starts to move. During the beverage delivery period, the heater element is switched off until delivery is complete (the pump is switched off) and the overheating algorithm is reset.

From heater 500, water flows through a pressure relief valve 501 to a flow meter 502 controlling the amount of water that is injected into the brewer 114. (No description is made of the tubing connecting these elements, since the necessity of such tubing is understood). In the present disclosure, a back check valve 503 is situated between the flow meter 502 and the pump 308 to prevent spurious output due to action (e.g., vibration) of the pump 308. The internal valve designs described above do not employ such flow regulation. In addition, only a single pump 308 is employed to pump water into brewer 114, whereas the internal valve designs described above generally employ two separate pumps.

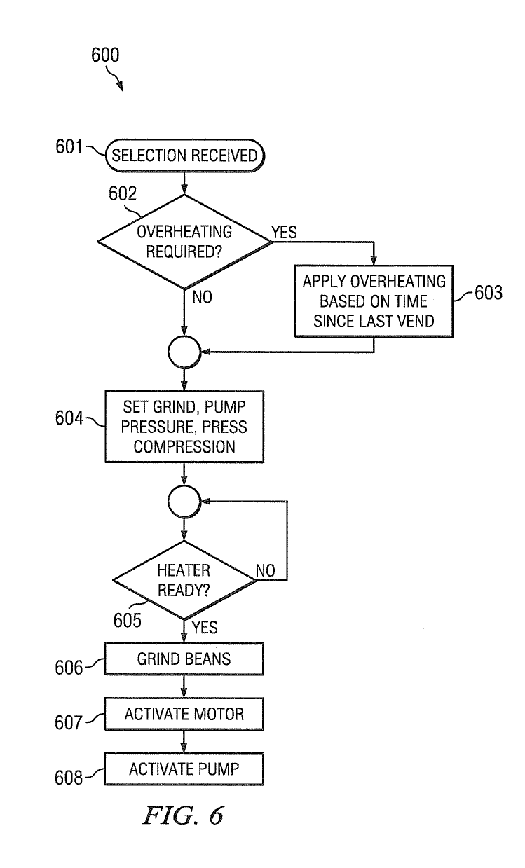

FIG. 6 is a high level flow diagram illustrating a process for brewing a beverage within the vendor 100 of FIGS. 1A and 1B. The process 600 is executed by controller 201, and begins with a customer selection of a beverage being received (step 601). A determination is made as to whether the customer's beverage selection required overheating by heater 500 (step 602), and if so overheating is applied based on the lapse of time since a last vend (step 603). Concurrently therewith, controller 201 may set the parameters for operation of the bean grinder (i.e., quantity and/or type of grind), the pump pressure and the press compression corresponding to the customer's beverage selection (step 604). Once the water is heated to the correct temperature (step 605), the grinder is activated (step 606) to produce the correct quantity and type of grind within the grinder for the selected beverage. The motor driving the press is then activated (step 607) to provide the required compression on the grinds within the brewer. The compression is determined based upon the current draw by the press drive motor. Next, the pump is activated (608) to provide water of the correct temperature at the pressure needed to produce the selected beverage within the brewer. The process then becomes idle until another beverage selection is made. Those skilled in the art will recognize that some steps are not explicitly shown, such as activating controls to release beans from the bean canister to the grinder or activating one or more valves allowing other ingredients to be mixed with the brewed beverage at the dispense head.

The present disclosure eliminates the need for an internal valve in brewing different types of beverages requiring different brewing pressure, employing compression of the grinds and water pressure to achieve the correct brew. A temperature algorithm matches heating of the water to the beverage being brewed, and a back check valve between a flow meter and pump prevents spurious output. In this manner, a greater consistency in the brew with less potential for mechanical wear is achieved.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A beverage brewing system, comprising:
a brewer including a movable press, an inlet through which heated water passes into the brewer and an outlet from which brewed beverage passes from the brewer; and
a controller coupled to a pump configured to pump the heated water into the brewer and to a motor configured to drive the press,
wherein the controller is configured to control brewing of at least two different beverages each requiring different brewing parameters, the controller configured to set both a compression on grinds within the brewer by the press and a pressure of the heated water to correspond to a selected beverage.

2. The beverage brewing system of claim 1, wherein the outlet from the brewing chamber does not include a valve associated therewith to alter an effective size of an opening for the outlet.

3. The beverage brewing system of claim 1, further comprising:
a grinder configured to selectively grind beans into at least one of a first type of grinds and a second type of grinds,
wherein the controller is configured to control both a type and a quantity of grinds produced by the grinder based upon the selected beverage.

4. The beverage brewing system of claim 3, wherein the controller is configured to cause the grinder to produce a first quantity of a first type of grinds when the beverage brewing system is brewing a first beverage and a second quantity of a second type of grinds when the beverage brewing system is brewing a second beverage.

5. The beverage brewing system of claim 1, wherein the controller is configured to set a first compression on grinds within the brewer corresponding to a first current draw by a motor driving the press when the beverage brewing system is brewing a first beverage and a second compression on grinds within the brewer corresponding to a second current draw by the motor driving the press when the beverage brewing system is brewing a second beverage.

6. The beverage brewing system of claim 1, wherein the controller is configured to cause the pump to inject the heated water into the brewer at a first pressure when the beverage brewing system is brewing a first beverage and to cause the pump to inject the heated water into the brewer at a second pressure when the beverage brewing system is brewing a second beverage.

7. The beverage brewing system of claim 1, wherein the controller is configured to control a heater element associated with the pump, the controller setting a heating period during which the heating element is activated based upon the selected beverage.

8. The beverage brewing system of claim 1, further comprising:
a back check valve situated between a flow meter and the pump, the back check valve configured to minimize spurious output by the pump due to vibration of the pump.

9. The beverage brewing system of claim 1, further comprising:
a user interface configured to receive a customer indication of the selected beverage and communicate a signal corresponding to the selected beverage to the controller.

10. A beverage vending machine including the beverage brewing system of claim 1, the beverage vending machine further comprising:
a payment system configured to receive payment from the customer for purchase of the selected beverage; and
one or more product storage valves coupled to the controller, wherein the controller is configured to cause each of the product storage valves to selectively release one or more of beans and additional ingredients into the beverage brewing system.

11. A method of brewing a selected one of at least two different beverages each requiring different brewing parameters within a beverage brewing system having a brewer including a movable press, an inlet through which heated water passes into the brewer and an outlet from which brewed beverage passes from the brewer, and a controller coupled to a pump configured to pump the heated water into the brewer and to a motor configured to drive the press, the method comprising:
setting a compression on grinds within the brewer by the press to correspond to the selected beverage; and
setting a pressure of the heated water to correspond to the selected beverage.

12. The method of claim 11, wherein the outlet from the brewing chamber does not include a valve associated therewith to alter an effective size of an opening for the outlet.

13. The method of claim 11, further comprising:
selectively grinding beans into at least one of a first type of grinds and a second type of grinds using a grinder within the beverage brewing system, wherein both a type and a quantity of grinds produced by the grinder are controlled based upon the selected beverage.

14. The method of claim 13, further comprising:
producing a first quantity of a first type of grinds when the beverage brewing system is brewing a first beverage and a second quantity of a second type of grinds when the beverage brewing system is brewing a second beverage.

15. The method of claim 11, further comprising:
applying a first compression on grinds within the brewer corresponding to a first current draw by a motor driving the press when the beverage brewing system is brewing a first beverage and a second compression on grinds within the brewer corresponding to a second current draw by the motor driving the press when the beverage brewing system is brewing a second beverage.

16. The method of claim 11, further comprising:
injecting the heated water into the brewer at a first pressure when the beverage brewing system is brewing a first beverage and at a second pressure when the beverage brewing system is brewing a second beverage.

17. The method of claim 11, further comprising:
activating a heater element associated with the pump for a heating period corresponding to the selected beverage.

18. The method of claim 11, further comprising:
minimizing spurious output by the pump due to vibration of the pump using a back check valve situated between a flow meter and the pump.

19. The method of claim 11, further comprising:
receiving a customer indication of the selected beverage; and
communicating a signal corresponding to the selected beverage to a controller within the beverage brewing system.

20. The method of claim 1, further comprising:
receiving payment from the customer for purchase of the selected beverage; and
selectively releasing one or more of beans and additional ingredients into the beverage brewing system.
